(19) United States
(12) Patent Application Publication
(10) Pub. No.: US 2020/0175076 A1
(43) Pub. Date: Jun. 4, 2020

(54) TRAINING AND IMPLEMENTING AN AUDIT GENERATION MODEL

(71) Applicant: Reveal Why, LLC, Orem, UT (US)

(72) Inventors: Burke Powers, Orem, UT (US); James Rich, Orem, UT (US)

(21) Appl. No.: 16/698,633

(22) Filed: Nov. 27, 2019

Related U.S. Application Data
(60) Provisional application No. 62/773,879, filed on Nov. 30, 2018.

(51) Int. Cl. G06F 16/9038; G06F 16/93; G06N 20/00; G06Q 50/00

(52) U.S. Cl. CPC G06F 16/9038; G06Q 50/01; G06N 20/00; G06F 16/93

(57) ABSTRACT

The present disclosure generally relates to systems, methods, and computer-readable media for training and implementing an audit generation model in connection with a collection of documents or other searchable content items available across a variety of platforms. In particular, systems disclosed herein receive a search query including one or more search elements for selectively identifying relevant documents from a larger collection of documents. The system can additionally identify portions of the documents responsive to the search query and generate a query result including the identified portions of documents and selectable user interface elements associated with the query result(s). The system can further provide the query result for presentation on a client device. The system can use an audit generation model to receive feedback for the query result(s) and utilize the feedback for tuning or further training the audit generation model.

### CROSS-REFERENCE TO RELATED APPLICATIONS

This application claims the benefit of U.S. Provisional Patent Application No. 62/773,879, filed on Nov. 30, 2018, which is hereby incorporated by reference in its entirety.

### BACKGROUND

Recent years have seen significant growth in the engagement of online users. Indeed, it is now common for social networking systems and other web platforms to provide tools that enable users of various platforms to search and/or navigate content shared via a particular website or on multiple websites. Searching and/or navigating content shared via web platforms, however, suffers from a variety of problems and drawbacks.

For example, as a result of increased engagement of online users, conventional systems for searching and presenting online content generally provide insufficient tools to enable users to accurately and effectively search through massive quantities of content. Indeed, effectively searching or navigating large quantities of digital content using conventional tools often requires specialized knowledge of search terms and Boolean operators, thereby preventing the vast majority of individuals from identifying relevant or helpful content. In addition, where massive quantities of content are shared across multiple platforms, conventional systems for searching and identifying relevant data have become unrealistic and computationally expensive.

### BRIEF DESCRIPTION OF THE DRAWINGS

FIG. 1 illustrates an example environment of a category auditing system in accordance with one or more embodiments.

FIG. 2 illustrates an example framework for presenting a category audit report and training a model of the category auditing system in accordance with one or more embodiments.

FIG. 3 illustrates an example process for generating and presenting a category audit report in accordance with one or more embodiments.

FIG. 4A illustrates an example graphical user interface of a client device for initiating generation of a category audit report in accordance with one or more embodiments.

FIG. 4B illustrates an example graphical user interface of the client device including an example presentation of a category audit report in accordance with one or more embodiments.

FIG. 5 illustrates an example series of acts for training and implementing a category auditing system in accordance with one or more embodiments.

FIG. 6 illustrates certain components that may be included within a computer system.

### DETAILED DESCRIPTION

The present disclosure generally relates to a category auditing system for training and implementing an audit generation model in connection with a collection of documents or other searchable content items available across a variety of platforms. In particular, as will be described in further detail below, the category auditing system receives a search query including one or more search terms for selectively identifying relevant documents from a larger collection of documents. The category auditing system can additionally apply an audit generation model to the collection of documents to generate a refined search query including one or more additional variables (e.g., latent variables) or other modification to the original search query. The category auditing system can further extract or otherwise identify portions of the collections of documents that match the refined search query to generate an audit report that includes a representation of the relevant results obtained from the collection of documents.

As will be described in further detail below, the category auditing system can additionally train or otherwise refine the audit generation model based on tracked interactions with one or more audit reports. For example, as will be discussed in further detail below, the category auditing system can generate and provide an audit report that includes a number of selectable options to enable an end-user (e.g., a user of a client device) to interact with results or entries from the audit report to indicate whether a particular result (e.g., a snippet of a document or the document itself) is relevant to the original search query (e.g., prior to generating the refined search query). The category auditing system can receive any number of user-selections and refine the audit generation model in a variety of ways. For example, the category auditing system can refine a machine learning model or algorithm(s) used in subsequent instances of generating refined searches. As another example, the category auditing system can refine a machine learning model or algorithm(s) used in subsequent instances of extracting portions of documents to return in response to subsequent search queries.

In addition, the category auditing system can be used to measure how precise and/or accurate certain results are with respect to a given search query. For example, in addition to refining and/or modifying an existing query, the category auditing system can collect result feedback to determine how accurate a given search query (e.g., an input query and/or refined search query) is at identifying relevant results. The category auditing system can utilize this data to refine subsequent search queries as well as provide a prediction or other indication as to the relevance of results within an audit report generated based on a given search query.

As illustrated in the foregoing discussion, the present disclosure utilizes a variety of terms to describe features and advantages of the category auditing system. Additional detail is now provided regarding the meaning of such terms. For instance, as used herein, a “document” or “electronic document” refers to any portion of digital content (e.g., a digital content item). For example, a document may refer to a defined portion of digital data (e.g., a data file) including, but not limited to, digital media, electronic document files, contact lists, folders, or other digital objects. In addition, in one or more embodiments described herein, a document refers to digital content shared via a social networking platform such as a post, message, comment, user-rating, or other digital content shared between users of the social networking platform. In addition to digital content provided by social networking platforms, documents may originate from any number of sources including, by way of example, blogs, news sites, forums, or other online sources. Documents may further include digital content originating from other sources such as call center logs, handwritten documents (e.g., a downloaded collection of physical documents), survey responses, etc. A document may refer to a user-composed document (e.g., a post or message including text composed by an individual) or a shared document (e.g., a post that is forwarded or shared to any number of recipients). As used herein, a “collection of documents” refers to a plurality of documents of similar or different types, which may include documents obtained from a single source (e.g., a single platform) or across multiple sources (e.g., third-party server devices, different platforms).

As used herein, a “search query” refers to a query provided by a client device as part of a request to search for results from a collection of documents. A search query may include a user-composed text string including any number of terms. In addition, or as an alternative, a search query may include one or more selected terms (e.g., categories, keywords) to include in selectively identifying documents or portions of documents from the collection of documents in response to the search query. Further, a search query may include an indication of one or more terms or series of words to exclude or otherwise utilize to filter or exclude from prospective results (e.g., negative terms).

As used herein, a “refined search query” refers to a variation or modification of a search query received as part of a request to search a collection of documents. As will be discussed in further detail below, a refined search query may refer to a query generated by the category auditing system using an audit generation model in accordance with one or more embodiments described herein. The refined search query may include one or more latent terms or variables based on historical data associated with previously generated audit reports. For example, the category auditing system may identify one or more latent variables such as adding a new search term not included within an original search query, removing a term (e.g., an irrelevant search term) included within the original search query, and/or emphasizing one search term over other search terms included within the search query to more accurately navigate or identify results from within the collection of documents.

In one or more embodiments described herein, the category auditing system identifies or otherwise extracts portions from the collection of documents corresponding to the refined search query. As used herein, “extracted portions” or “query results” refer interchangeably to documents or portions of documents that match or otherwise correspond to the refined search query. For example, an extracted portion or query result may refer to a snippet (e.g., a text snippet) from a document determined to be relevant to the refined search query based on an analysis of the search query (e.g., using natural language processing or other query analysis methods) and application of the analysis to the collection of documents. In one or more implementations, an extracted portion or query result may include an image, video, or other portion of a source document other than text snippets. Indeed, an extracted portion of a source document or query result may include a combination of text, images, or other type of digital content that may be consumed via a client device.

As mentioned above, the category auditing system can generate and provide an audit report to a client device. As used herein, an “audit report” includes a file or documents including a representation of any number of results (e.g., extracted portions) of a search query. For example, the audit report may include a webpage, document file, or other data object including selected information from the collection of documents determined or otherwise predicted to be relevant based on the refined search query. In one or more embodiments, the audit report includes one or more selection options that enables an end-user to provide feedback indicating whether one or more results are more or less relevant to the search query than other results within the audit report. As will be discussed in further detail below, an audit report may include any information associated with a search query, refined search query, and/or results of the search query. Indeed, in one or more embodiments, an audit report may include information about an audit generation model used for generating the audit report. Additional detail with regard to information that may be included within an audit report is provided in further detail below.

In one or more embodiments, the category auditing system utilizes an audit generation model to generate the audit report. In particular, the category auditing system may implement an audit generation model trained to perform some or all of the acts described herein that make up the process of generating and providing the audit report. For example, the audit generation model may include one or more algorithms or discrete models trained to perform tasks including generating a refined search query, selectively identifying a subset of a collection of documents to preserve processing resources, extracting relevant portions of documents in response to a search query, and determining information to provide within an audit report. In one or more embodiments, the audit generation model includes one or multiple machine learning models. In addition, or as an alternative, the audit generation model may include various algorithms, filtering rules, or other algorithms to enable the audit generation model to more accurately identify relevant results in response to a search query.

In one or more implementations, an algorithm or model may be trained using a sample set of training data, which may further be used to process all original search results that have been returned to search for accuracy and determine whether a query should be changed. For example, while one or more embodiments described herein describe generating a refined search query prior to generating the audit report, the category audit system may alternatively generate an audit report based on the original search query and, based on result feedback, provide recommendations or additional terms or variables to consider in generating a new search query as part of a process of generating a new audit report for the same user or device (e.g., rather than or in addition to gradually refining the algorithms or models over time).

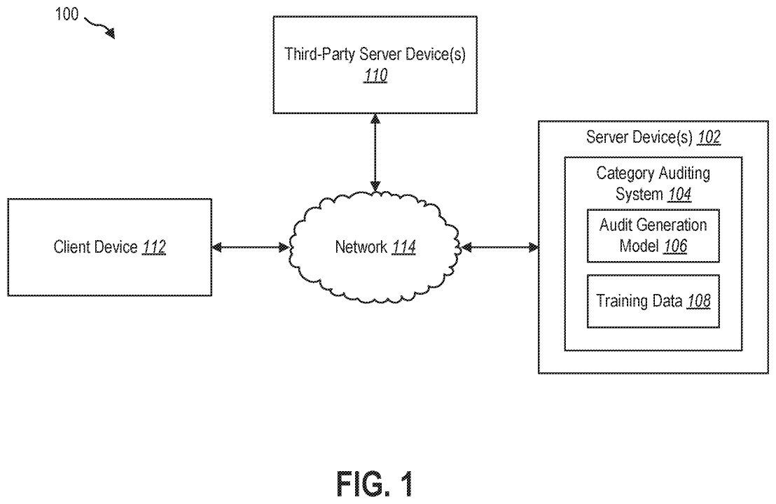

Additional detail will now be provided regarding the category auditing system in relation to illustrative figures portraying example implementations. For example, FIG. 1 illustrates an example environment 100 for generating and providing an audit report for a collection of documents based on a search query in addition to utilizing and refining an audit generation model implemented by a category auditing system.

As shown in FIG. 1, the environment 100 includes server device(s) 102 including a category auditing system 104 thereon. As further shown in FIG. 1, the category auditing system 104 includes an audit generation model 106 implemented thereon. The category auditing system 104 may additionally include a data storage having training data 108 stored thereon. The environment 100 may further include third-party server device(s) 110 and a client device 112, which may be associated with an end-user. Each of the client device 112, third-party server device(s) 110, and server device(s) 102 may communicate over a network 114. While FIG. 1 illustrates an example in which the category auditing system 104 is implemented on the server device(s) 102, one or more features and functionalities described herein in connection with the category auditing system 104 can similarly be implemented on the client device 112 (e.g., using a locally installed application associated with the category auditing system 104) and/or on the third-party server device(s) 110.

The client device 112 may refer to any computing device associated with a user for use in providing and receiving data from the category auditing system 104. For example, the client device 112 may refer to a consumer electronic device including, by way of example, mobile devices, desktop computers, or other types of computing devices. Moreover, as mentioned above, the client device 112 and server devices can communicate over the network 114, which may refer to one or multiple networks that use one or more communication protocols or technologies for transmitting data. For example, the network 114 may include the Internet or another data link that enables transport of electronic data between server device(s) 102 and any other devices of the environment 100.

As mentioned above, the category auditing system 104 facilitates accurate and efficient identification of portions of documents related to a given search query generated by a client device. For example, in at least one embodiment, the client device 112 provides a search query, which may include a user-generated search query composed by a user of the client device 112. The search query may include any number or combination of different search elements (e.g., text, categories, images, or other types of digital content) usable for identifying corresponding query results. In one or more implementations, the search query includes free-form text and/or one or more selected categories or search terms to include within a request to search a collection of documents to identify relevant portions of the documents associated with the search query. The client device 112 may transmit or otherwise provide the search query to the category auditing system 104.

Upon receiving the search query, the category auditing system 104 may utilize the audit generation model 106 to generate a refined search query based on one or more algorithms that make up the audit generation model 106. In particular, the category auditing system 104 may utilize the audit generation model 106 to determine one or more latent variables to consider in applying the audit generation model 106 to a collection of documents for identifying relevant results in response to the search query. For example, the category auditing system 104 may replace one or more search terms from the search query with more relevant or helpful search terms to use in extracting portions of documents from the collection of documents.

As another example, the category auditing system 104 may add or subtract search terms from the original query received from the client device 112. For example, the category auditing system 104 may identify one or more exclusion terms or variables that include negative limitations for search results. Indeed, the category auditing system 104 can generate any number of latent variables to apply to the documents and/or modify the search query in a number of ways to more accurately and efficiently identify relevant portions (e.g., snippets) of the collection of documents.

The category auditing system 104 can additionally identify a collection of documents to search based on the search query. The category auditing system 104 can identify collections of documents from a number of different sources and in a variety of ways. For example, the category auditing system 104 can identify documents from a particular social networking platform (from a collection of shared posts) or between multiple platforms (e.g., hosted by the third-party server device(s) 110). The category auditing system 104 can identify documents from a combination of social networking systems and other platforms (e.g., a document database).

As shown in FIG. 1, the category auditing system 104 may obtain documents from one or multiple third-party server device(s) 110. Indeed, the documents may include documents from any number of sources including, by way of example, a webpage, a collection of webpages, a remote database, a local database, a data storage system, or a social networking system. Moreover, the category auditing system 104 can identify a static collection of documents (e.g., a previously collected or non-changing collection of documents) or, alternatively, a dynamic collection of documents (e.g., a real-time feed of documents as they are shared to a social networking system and monitored or otherwise accessible in real-time by the category auditing system 104).

Upon generating the refined search query, the category auditing system 104 can apply the audit generation model 106 to the collection of documents based on the refined search query to generate an audit report. In particular, the category auditing system 104 can apply the audit generation model 106 to identify or extract portions of the collection of documents determined to be relevant to the search query based on the algorithms, rules, and training of the audit generation model 106. In one or more embodiments, the category auditing system 104 identifies snippets of the collection of documents determined to be relevant to the search query.

The category auditing system 104 can additionally provide the audit report to the client device 112 for presentation via a graphical user interface on the client device 112. For example, the category auditing system 104 can provide the audit report directly to the client device 112 over the network 114 to enable the client device 112 to provide a navigable and/or interactive display of the audit report. In one or more embodiments, the category auditing system 104 provides the audit report by providing a presentation of the audit report via a web interface on the client device 112. For example, the category auditing system 104 can generate the audit report and provide online access to the client device 112 for display via a navigable web interface.

As will be discussed in further detail below, client device 112 can enable a user of the client device 112 to interact with the audit report and provide result feedback indicating which results are more or less relevant to the search query. In one or more embodiments, the category auditing system 104 (or client device 112) provides selectable options that enable a user to interact with a presentation of the audit report to manually indicate which entries of the audit report are relevant, not relevant, or unknown. Alternatively, the category auditing system 104 may dynamically learn relevance based on detected selections or other interactions by the user with respect to information presented within the audit report.

In addition to training and utilizing the audit generation model 106 to generate a refined search query and extract results from a collection of documents, the category auditing system 104 can additionally train and utilize the audit generation model 106 to selectively identify documents from a larger collection of documents to consider in generating the results. For example, result feedback (described in further detail below) may be used to further expand or contract a collection of documents to broaden or narrow a search of relevant documents.

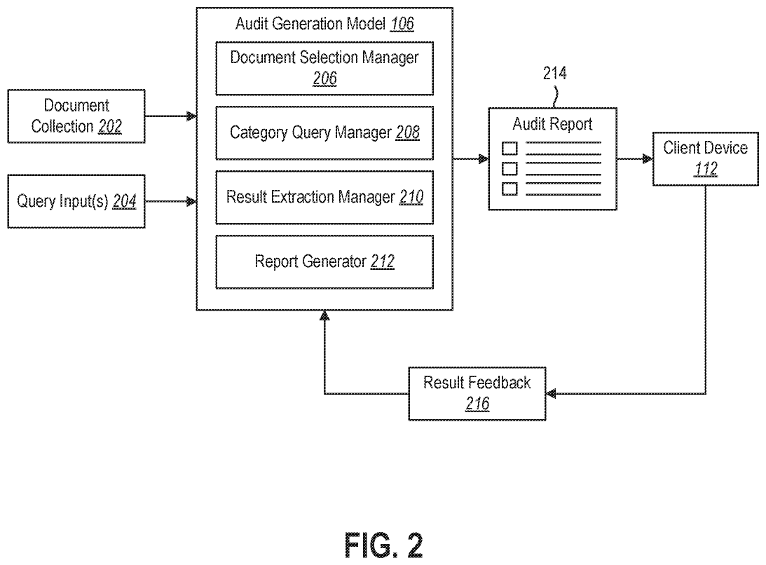

FIG. 2 illustrates an example implementation of the audit generation model 106 to generate an audit report based on a collection of documents and a search query and further in view of result feedback receiving by the category auditing system 104. As shown in FIG. 2, the category auditing system 104 provides inputs to the audit generation model 106 including a document collection 202 and query inputs 204. As mentioned above, the document collection 202 may include any number of documents from multiple platforms or sources. In addition, the query inputs 204 may include one or more user-provided inputs including keywords or categories provided to the category auditing system 104 by a client device.

As shown in FIG. 2, the audit generation model 106 may include a number of components 206-212 for generating and providing an audit report 214 to the client device 112. For example, the audit generation model 106 may include a document selection manager 206. The document selection manager 206 may identify or otherwise obtain the collection of documents from a specified source. For example, in one or more embodiments, the query inputs 204 or other input provided by the client device 112 may include an indication of one or more specific platforms or social networks from which to obtain the documents. Accordingly, the document selection manager 206 may identify a subset of all available documents in accordance with one or more inputs provided by the client device.

In one or more embodiments, the document selection manager 206 further narrows the document collection 202 by selectively identifying a subset of documents based on one or more of the query inputs 204. For example, where the query inputs 204 include a keyword or selected category, the document selection manager 206 may perform a simple keyword filter algorithm to discard or exclude any number of irrelevant documents without performing any additional analysis. As another example, and as will be discussed further below, the document selection manger 206 may filter documents based on a selected platform (e.g., news platform, social networking platform) or document source. Accordingly, in one or more embodiments, the document selection manager 206 performs an initial filtering process to significantly narrow the document collection 202 to a relevant subset prior to applying one or more additional algorithms or models included within the audit generation model 106 to the subset of documents. In this way, the document selection manager 206 may significantly reduce processing resources needed when applying the audit generation model 106 to the document collection 202.

As shown in FIG. 2, the audit generation model 106 additionally includes a category query manager 208. The category query manager 208 may generate a refined search query based on the query inputs 204 in addition to result feedback 216 based on historical data associated with interactions and other data collected in connection with previously generated audit reports. For example, the category query manager 208 may recognize a trend (e.g., for a specific user, or across multiple users performing search queries) of terms, phrases, or certain topics that affect whether a particular document or portion of a document is relevant to a search query (e.g., a category specified within a search query). In one or more embodiments, the category query manager 208 generates or otherwise identifies one or more latent variables to modify a search query or otherwise generate a refined search query for more effectively analyzing and identifying relevant documents (e.g., from the narrowed subset of the document collection 202). In accordance with various examples described herein, the latent variables may include specific terms to include or exclude and/or may include constraints to apply when analyzing documents and/or terms of a search query.

As further shown in FIG. 2, the audit generation model 106 includes a result extraction manager 210. The result extraction manager 210 can receive as input the refined search query in addition to historical data associated with previously generated audit reports (e.g., previously received result feedback 216) to train any number of algorithms to analyze or parse a set of documents to identify one or more relevant documents and/or identify portions of the documents that are relevant to the refined search query.

The result extraction manager 210 may utilize any number of models or algorithms. For example, in one or more embodiments, the result extraction manager 210 implements or utilizes a machine learning model or algorithm(s) trained to identify or extract snippets of text (e.g., a single snippet or multiple snippets from the same document) from a set of documents based on an analysis of a search query (e.g., the refined search query) and content included within the document(s). The result extraction manager 210 may utilize any number of methods or techniques to analyze the documents in view of the search query including natural language processing, capture concepts, text or phrase classification, matching, vectorization, tracking, augmentation, or other forms of analysis.

As further shown, the audit generation model 106 includes a report generator 212 for generating the audit report 214. For example, the report generator 212 may compile any number of relevant results (e.g., all of the results, a subset of results) and compile the relevant results within a file or document to provide to the client device 112 for presentation via a graphical user interface of the client device 112. The report generator 212 can include all relevant results or snippets within the audit report 214. Alternatively, the report generator 212 can include a random sample or a predetermined number of the most relevant results within the audit report 214 based on the analysis performed by the result extraction manager 210.

The audit report 214 may include any information associated with the relevant results. For example, the audit report 214 may include extracted snippets from source documents (e.g., rather than including entire documents within the report). In addition, the audit report 214 may include an identification of the platform (e.g., social networking platform), an identification of the individual (e.g., a username) who shared or uploaded the file. The audit report 214 may include an indication of relevance as determined by the result extraction manager 210. Indeed, the audit report 214 may include any information associated with the results or documents within the audit report 214.

In addition to various types of information about the specific results and/or associated source documents, the audit report 214 may additionally include information about how the query results were generated. For instance, the audit report 214 may include an indication of how an original search query was modified to generate a refined search query. The audit report 214 may additionally include a history of interactions or user selections detected leading up to generation of the audit report 214. In one or more implementations, the audit report 214 includes operators, terms, weighted values, categories, or other data used by an algorithm or machine learning model in generating results of the audit report 214. In one or more embodiments, the audit report 214 includes one or more suggested modifications or related combinations of terms, words, or other search elements that may be better equipped to produce relevant results that align with the original search query.

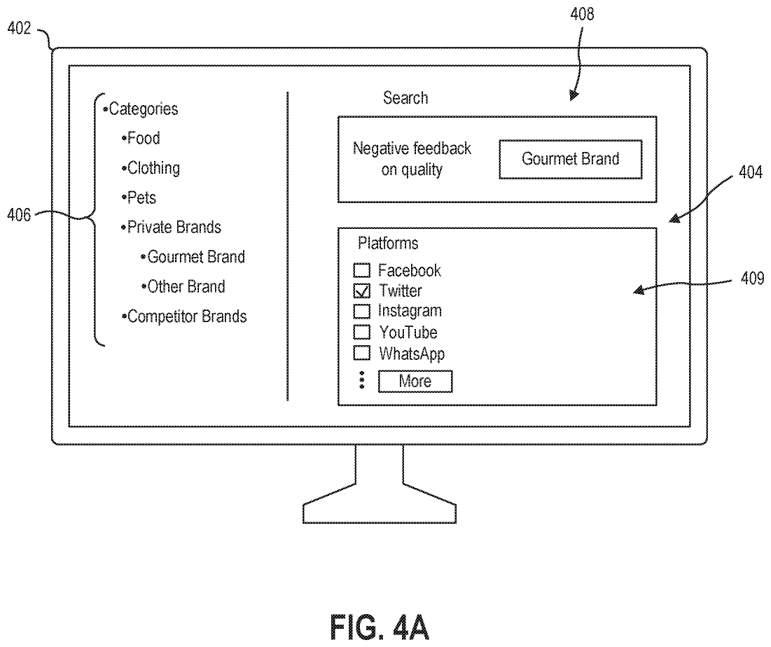

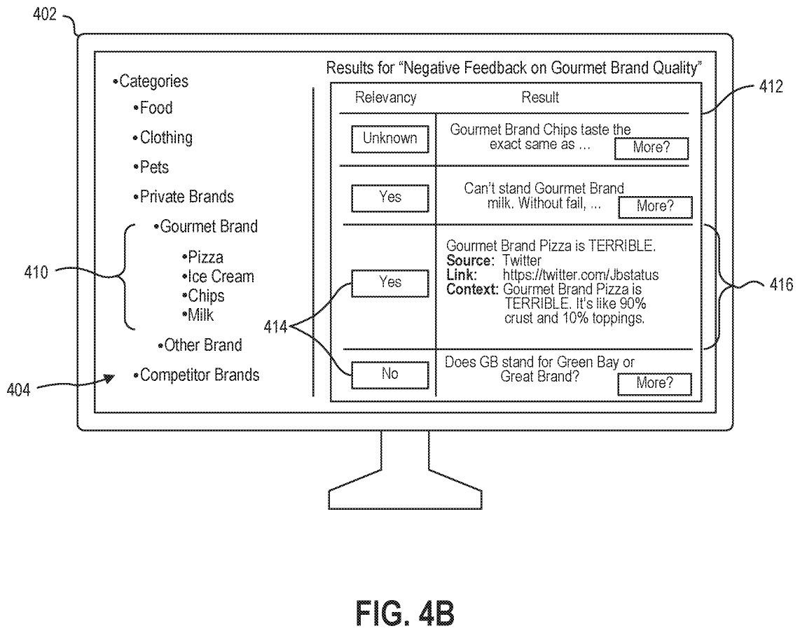

While the audit report 214 may include any number of the example types of information mentioned above, the client device 212 may include a display of some or all of the information included within the audit report 214. For instance, the client device 112 may provide a display of a portion of the information included within the audit report 214 such as a list of relevant results and a display of extracted snippets of source documents, the client device 212 may hide or collapse certain portions of the information in example presentations of the audit report 214. Indeed, as will be discussed below in connection with FIG. 4B, a user of the client device 112 may interact with a graphical user interface to obtain additional information from the audit report 214 (e.g., by selecting or otherwise interacting with specific results from the audit report 214).

As mentioned above, and as will be discussed further, the audit report 214 can additionally include or otherwise provide interactive functionality that enables a user of the client device 112 to interact with the audit report 214 to generate result feedback 216. For example, the audit report 214, when presented via a graphical user interface of the client device 112, may include selectable options to enable a user of the client device 112 to interact with specific entries of the audit report 214 and manually indicate whether a particular entry is relevant to the search query. The user may select any number of entries to indicate classifications for the results including, for example, “relevant,” “not relevant,” “unknown” or other classification.

In addition to manual feedback, the result feedback 216 may include tracked feedback about the audit report 214. For example, the category auditing system 104 may track or otherwise observe interactions with one or more entries of the audit report 214 and determine, based on the observer interactions (or lack of interactions), that relevancy or non-relevancy of results included within the audit report 214. Examples of tracked activity may include views, downloaded cookies, clicks on specific entries or links, duration of time that a certain entry has been opened or viewed, etc.

As shown in FIG. 2, the result feedback 216 may be used to further refine or train one or more processes performed using the audit generation model 106. For example, the result feedback 216 may be used to refine the process performed by the category query manager 208 to determine a refined search query. Indeed, the result feedback 216 may indicate that certain search terms may have a high or low correlation with relevant or non-relevant result feedback. Accordingly, the category auditing system 104 may associate latent variables including one or more additional search terms that should be added to search queries associated with one or more associated categories or topics.

In addition to indicating additional terms that may further narrow or broaden the scope of a document search, the category auditing system 104 may additionally identify one or more negative correlations. For example, audit generation model 106 may learn that where a search query includes a first term, results often include a secondary term that significantly changes the meaning of a result and renders the result less related to other results that have a high relevance with the topic of the search query. Accordingly, the audit generation model 106 may learn to exclude, minimize, or otherwise discount the second term when query inputs 204 associated with the first term are received.

In one or more embodiments, upon receiving the result feedback 216, the audit generation model 106 can learn that a set of results includes multiple subcategories of results that have limited relevance. For example, where a search query includes a keyword of “pizza” and “quality,” the results from one or multiple audit reports 214 may initially include results about “cheese” and “meat,” where the results about cheese relate to a first type of pizza while the results about meat relate to a second type of pizza. Based on this identified trend or distinction (e.g., learned trend or distinction), the category auditing system 104 may provide one or more tools to an end-user to enable the user to further refine a search query. As an example, upon receiving a search query about pizza (or any time after the audit generation model 106 learns the category distinction), the category auditing system 104 may provide one or more selectable options for a user to indicate a subcategory. This provides a more accurate search query, which enables the category auditing system 104 to search a smaller quantity of documents when generating the refined search query and analyzing a subset of a larger collection of documents to extract search results.

In addition to utilizing the result feedback 216 to refine the process performed by the category query manager 208 to generate the refined search query, the result feedback 216 may additionally be used by the result extraction manager 210 to more accurately extract results from the documents over time. Indeed, the result feedback 216 may be used to hone or otherwise fine-tune algorithms or machine learning model(s) used by the result extraction manager 210 to selectively identify portions of documents to include within an audit report 214.

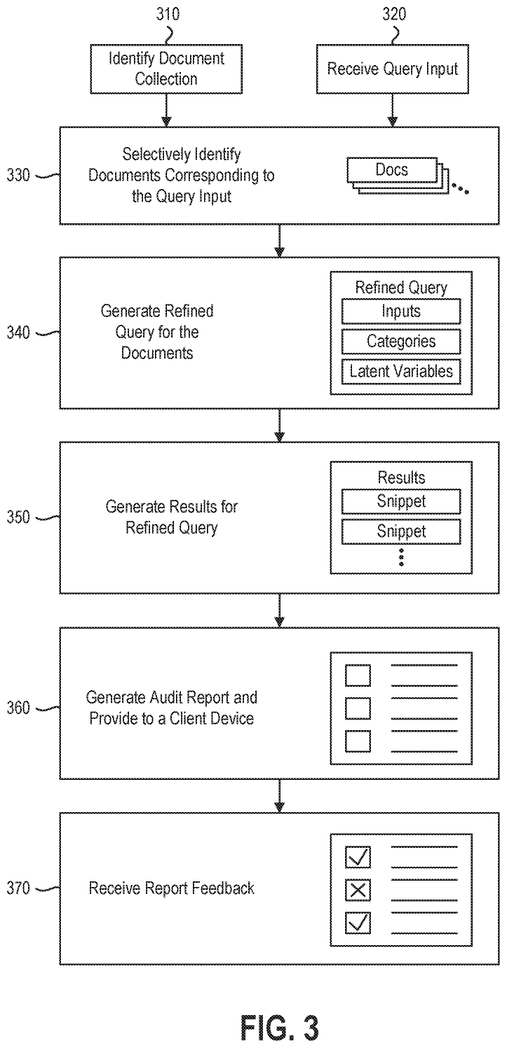

FIG. 3 illustrates an example embodiment for implementing an audit generation model to generate and provide an audit report to a client device in accordance with one or more embodiments described herein. In particular, FIG. 3 illustrates a series of acts that the category audit system 104 may perform in generating an audit report as well as fine tuning a model to more accurately and more efficiently identify results including portions of documents to include within subsequently generated audit reports.

As shown in FIG. 3, the category audit system 104 may perform an act 310 of identifying a document collection. The document collection may include any number of documents accessible to the category audit system 104. In accordance with one or more embodiments described above, the documents may include documents from a selected (e.g., user-selected) platform or other storage space(s) of documents accessible to the category audit system 104.

The category audit system 104 may additionally perform an act 320 of receiving a query input. The query input may include free-form text that the category audit system 104 parses to limit the collection of documents. The query may additionally include one or more selected categories or topics presented to a user providing the search query. For example, based on training of the audit generation model 106, the category audit system 104 may provide one or more categories and sub-categories determined to be relevant to a particular topic. As mentioned above, the query may include other search elements, such as images, portions of images, videos, audio files, or other elements that may be used to search the collection of documents.

In one or more embodiments, the category audit system 104 presents a list of available categories or topics that the category audit system 104 has been tasked with monitoring by a client. For example, an individual or business may request a predefined number of topics or categories of interest that the category audit system 104 can develop and train the audit generation model 106 to consider in generating the audit report. The category audit system 104 may present any number of categories or selectable topics via a graphical user interface of a client device. This is discussed by way of example below in connection with FIG. 4A.

As shown in FIG. 3, the category audit system 104 can perform an act 330 of selectively identifying documents corresponding to the query input. In particular, the category audit system 104 can selectively narrow the collection of documents to a subset of documents prior to performing additional processing on the collection of documents. This may include identifying a subset of documents based on one or more search elements from the search query and/or based on a selected document source or platform. As an example, in one or more embodiments, the category audit system 104 selectively identifies documents by filtering the collection of documents based on one or multiple keywords included within the received query input. In this way, the category audit system 104 can perform an initial simple filtering that utilizes fewer processing resources than other models employed by the category audit system 104 in generating a refined query and/or analyzing content of select documents.

The category audit system 104 can additionally perform an act 340 of generating a refined query for the documents. As discussed above, this may include adding one or more keywords to keywords identified from within the original search query. In addition, this may include identifying one or more categories which the audit generation model 106 is trained to analyze. In one or more embodiments, the category audit system 104 identified one or more latent variables including weights to apply to certain terms and/or terms to add or subtract from a refined search query that more accurately enable the category audit system 104 to identify relevant results within the selected subset of documents.

The category audit system 104 can additionally perform an act 350 of generating results for the refined query. In particular, the category audit system 104 can apply the refined query and a machine learning model to the identified subset of documents to identify snippets or other results from within the documents to include within an audit report. The category audit system 104 can identify any number of snippets or results from the collection of documents.

The category audit system 104 can additionally perform an act 360 of generating an audit report and provide the audit report to a client device. In generating the audit report, the category audit system 104 can identify any number of the results to include within the audit report. In one or more embodiments, the category audit system 104 identifies the most relevant results (e.g., predicts the most relevant results based on algorithms or instructions of the audit generation model 106). Alternatively, in one or more embodiments, the category audit system 104 identifies a random or pseudorandom set of results to include within the audit. By identifying random result or at least including some results of unknown relevance, the category audit system 104 facilitates receiving feedback to train the audit generation model 106 to more accurately or efficiently analyze a set of documents to identify relevant results.

As shown in FIG. 3, the category audit system 104 can perform an act 370 of receiving report feedback. As indicated above, the feedback may include manually selected indicators of relevancy with respect to individual entries of the audit report. In one or more embodiments, the category audit system 104 monitors, tracks, or observes interactions (or lack of interactions) by individuals to further fine-tune the audit generation model 106.

As shown in FIG. 3, the result feedback may be utilized in subsequent instances of selectively identifying documents, generating refined queries, or otherwise utilizing the audit generation model 106 in performing subsequent searches. As an example, the result feedback may be used to more accurately emphasize or discount certain terms or combinations of terms. The category audit system 104 can further utilize the result feedback to identify latent variables that improve upon the accuracy and/or efficiency of the audit generation model 106 (e.g., the category query manager 208) in generating future instances of refined search queries.

As further shown, the result feedback may be utilized in subsequent instances of generating results (e.g., extracting portions of documents) in response to subsequently received query inputs. For example, the category audit system 104 can fine-tune algorithms or models used in analyzing documents and/or applying a refined query to a collection of documents (or subset of documents from a collection of documents) to determine relevant results that correspond to a received query input.

Referring now to FIG. 4A, this figure illustrates an example graphical user interface presented via a client device in accordance with one or more embodiments. In particular, FIG. 4A illustrates a client device 402, which may refer to an example of the client device 112 described above, and which includes a graphical user interface 404 for presenting information to a user.

FIG. 4A illustrates an example search interface of the category audit system 104 including a listing of categories 406 for which an end-user may have an interest. In particular, the category audit system 104 may identify categories based on prior searches by the user of the client device 402 (or other users of the category audit system 104). The category audit system 104 may additionally identify categories for which a user of the client device 402 has requested the category audit system 104 to audit. Accordingly, the listing of categories 406 shown in FIG. 4A illustrates one example of a listing of categories for which the category audit system 104 has developed and trained an audit generation model 106 to analyze and generate one or more audit reports.

In the illustrated example, the listing of categories 406 includes categories such as food, clothing, pets, private brands, and competitor brands. As shown in FIG. 4A, the listing of categories 406 may include subcategories for one or more of the individual categories. As mentioned above, the category audit system 104 may dynamically determine one or more sub-categories (as well as further layers of sub-categories) based on dynamically received result feedback in connection with certain results from previously generated audit reports (for the user of the client device 402 or for multiple users of any number of client devices). In addition, the client device 402 may further expand any of the categories based on a user selection of a given category.

As mentioned above, FIG. 4A illustrates an example search interface including a search window 408 within which a user may compose or otherwise generate a search query. For example, a user may type “negative feedback on Gourmet Brand quality” indicating a desire to view results or snippets from a plurality of documents associated with negative experiences of customers with products from the Gourmet Brand. In one or more embodiments, a user of the client device 402 simply types or composes the search query using a keyboard or other input device. Alternatively, in one or more embodiments, the listing of categories 406 are selectable, enabling the user of the client device 402 to select a listed category to indicate a topic for the search (e.g., “Gourmet Brand”). Accordingly, the resulting search query may include a fully composed query, a selected query, or a combination of composed text and selected option(s).

In accordance with one or more embodiments described above, the category audit system 104 can generate a refined query including one or more modifications to the typed query and/or latent variables to consider when performing a search of documents. This may include a string of Boolean operators (not shown), instructions for performing a hierarchical analysis of the documents, or simply a refined query including a slightly different combination of words more equipped to product relevant results that align with the original search query typed by the user.

As shown in FIG. 4A, the category audit system 104 can include a listing of available platforms 409 from which to search documents and identify results of the search query. For example, the category audit system 104 may include a list of any number of platforms or sources of documents for which the category audit system 104 has access. A user of the client device 402 can select one or multiple platforms from the listing of available platforms 409 to further narrow or broaden the search of documents across one or multiple platforms. For example, as shown in FIG. 4A, the available platforms 409 may include example platforms such as “Facebook,” “Twitter,” “Instagram,” “YouTube,” and “WhatsApp.” The available platforms 409 may include any number and type of platforms including, by way of example, media platforms, news platforms, content sharing platforms, or any other public or private platform that is accessible to the audit generation model 106.

FIG. 4B illustrates an example presentation of the resulting audit report generated and provided to the client device 402 by the category audit system 104. For example, the category audit system 104 may include a listing of relevant sub-categories 410 associated with the “Gourmet Brand” category or topic identified within the search query. The sub-categories may include additional layers of sub-categories. In addition, a user of the client device 402 may select one or more of the sub-categories to further narrow the search of documents and refine the results presented within the audit report.

As shown in FIG. 4B, the graphical user interface 404 further includes a presentation of the audit report 412 including any number of entries. In the example shown in FIG. 4B, the entries include snippets from specific documents including quoted portions of the documents within the right column of the audit report 412. In addition, each entry includes an indication of relevancy for the specific entry. Example indications of relevancy may include “yes” (indicating that an entry is relevant), “no” (indicating that an entry is not relevant), and “unknown” (indicating unknown relevancy for an entry). An initial display of the audit report 412 may include default designations of relevancy as “unknown” or “N/A,” and may change in response to detecting a user selection of a selectable icon 414 for one or more respective entries.

For example, as shown in FIG. 4B, a user of the client device 402 may select “unknown” for a first entry where the snippet does not provide a clear indication of whether the quality of the Gourmet Brand product is associated with a positive or negative experience. The user may additionally select “yes” for the second and third entries indicating that the results are relevant to negative customer experiences with Gourmet Brand products. Moreover, the user may select “no” for the fourth entry to indicate that the result is not relevant.

As indicated above, the category audit system 104 may utilize each of the selected indications of relevancy to further train or refine an audit generation model in accordance with one or more embodiments described above. For example, the category audit system 104 may provide positive feedback for the second and third entries to indicate types of entries to identify in the future. In addition, the category audit system 104 may provide the negative feedback for the fourth entry to indicate types of entries to not identify in the future. Further, the category audit system 104 may provide the neutral feedback for the first entry to determine any other refinements to the model to more accurately or efficiently identify results.

As further shown in FIG. 4B, the category audit system 104 enables a user of the client device 402 to select and expand one of the entries to view additional information about the result and/or document from which the result was extracted. For example, in response to selecting the third entry of the audit report 412, the category audit system 104 provides (or causes the client device or application on the client device to provide) additional information 416 including the snippet, a source of the snippet (e.g., Twitter), a selectable link to the source document (e.g., a URL), and additional text or context from the document associated with the snippet. This may include an entire post or sentence or paragraph from which the snippet was extracted, providing a user of the client device with additional information about the result.

This expanded view including additional information would similarly be useful to enable the user of the client device 402 to further inform themselves on the relevancy of an entry prior to selecting a “no,” “yes,” or “unknown” indication of relevance. For example, the user could select the first entry to view additional information to accurately determine whether the entry is relevant or not relevant rather than “unknown,” as shown in FIG. 4B.

In accordance with one or more embodiments, the audit report can include additional information, such as an indication of how the query result was produced. This information may be included in the expanded view, which may present additional information from the audit report not initially displayed via a presentation of the audit report 412. The expanded view can display data relating to how the system refined the initial search query, such as displaying one or more modifications to the typed query and/or latent variables that were considered by a machine learning model. This displayed data may include a string of Boolean operators and terms, indications of selections used in performing a hierarchical analysis of the documents, indications of categories considered important and used by a machine learning model, or simply displaying of the refined query, for example that included a slightly different combination of words more equipped to produce relevant results that align with the original search query typed or input by the user.

Many of the features and functionalities described herein are described in connection with specific examples or embodiments. It will be understood that different features and acts described in connection with a specific example or implementation may apply to other examples or implementations. Moreover, it will be understood that alternative implementations may omit, add to, reorder, and/or modify any of the acts or series of acts described herein. In addition, the category audit system 104 may perform acts described herein as part of a method, Alternatively, the category audit system 104 may implement a non-transitory computer readable medium including instructions that, when executed by one or more processors, cause a computing device (e.g., a server device) to perform features and functionality described herein. In still further embodiments, a system can perform the features and functionality described herein.

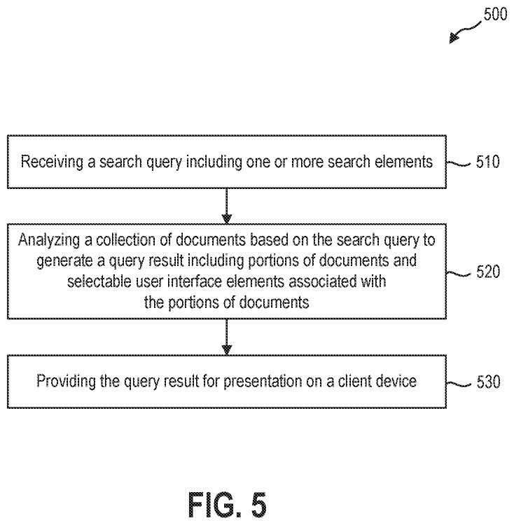

Turning now to FIG. 5, this figure illustrates an example flowchart including a series of acts for training and implementing an audit generation model in accordance with one or more embodiments described herein. While FIG. 5 illustrates acts according to one or more embodiments, alternative embodiment may omit, add to, reorder, and/or modify any of the acts shown in FIG. 5. The acts of FIG. 5 may be performed as part of a method. Alternative, a non-transitory computer-readable medium can include instructions that, when executed by one or more processors, causes a computing device (or multiple devices) to perform the acts of FIG. 5. In still further embodiments, a system can perform the acts of FIG. 5.

FIG. 5 illustrates a series of acts 500 for receiving and analyzing a search query to generate and provide query results in accordance with one or more embodiments described herein. For example, the series of acts 500 may involve training and implementing an audit generation model in accordance with one or more examples discussed herein. As shown in FIG. 5, the series of acts 500 includes an act 510 of receiving a search query including one or more search elements.

As further shown, the series of acts 500 includes an act 520 of analyzing a collection of documents based on the search query to generate a query result including portions of documents and selectable user interface elements associated with the portions of documents. For example, the act 520 may include analyzing, using a processor, a collection of documents to generate a query result based on the search query where the query result includes data for displaying portions of the collection of documents identified in the query result. Each document portion may be visually associated with a selectable user interface element that accepts user input to indicate relevancy of the document portion. As further shown, the series of acts 500 may include an act 530 of providing the query result for presentation on a client device.

The collection of documents may include various types of documents from different sources. For example, the collection of document may include a plurality of digital content items shared via a social networking system. The collection of documents may include a plurality of user-composed social networking posts shared via the social networking system. In one or more implementations, the collection of documents includes a plurality of digital content items shared across a plurality of social networking systems.

In one or more implementations, the series of acts 500 further includes generating from the search query, a refined search query by identifying one or more categories associated with the one or more search elements. In one or more embodiments, the search query includes one or more user-selected categories corresponding to a plurality of predetermined categories used to search the collection of document. The series of acts 500 may further include identifying a reduced set of documents from the collection of documents prior to generating the refined search query. In one or more implementations, generating the refined search query includes identifying one or more terms not included in the one or more search elements to utilize in identifying portions of the collection of documents.

In one or more embodiments, the data for displaying portions of the collection of documents includes a visual indication of how the query result was generated. The visual indication may additionally be associated with a respective document portion from the identified portions of the collection of documents. Further, analyzing the collection of document may include using a machine learning model trained to obtain portions of a given collection of documents. Moreover, the visual indication of how the query result was generated may include data used by the machine learning model to select the respective document portion. In one or more embodiments, the data for displaying the portions of the collection of documents includes text snippets from the collection of documents.

In one or more embodiments, the data for displaying the portions of the collection of documents includes a subset of the portions of the collection of documents for presentation on the client device. For example, the data for displaying the portions of the collection of documents may include a random sample of the portions of the collection of documents. The data for displaying the portions of the collection of documents may additionally (or alternatively) include a subset of the portions of the collection of documents determined to have a higher relevance to the search query than other portions.

As mentioned above, in one or more embodiments, analyzing the collection of documents includes using a machine learning model trained to generate the search query and obtain the portions of the collection of documents. The series of acts 500 may further include receiving data, input via a selectable user interface element included in the search result, an indication of relevance associated with a displayed document portion. The series of acts 500 may also include updating the machine learning model in view of the received indication of the user selection. In one or more embodiments, the series of acts 500 includes receiving an additional search query and applying the updated machine learning model to the additional search query to generate an additional query result based on the additional search query.

In accordance with one aspect of the present disclosure, a method is disclosed that includes receiving a search query comprising one or more search terms, applying an audit generation model to a collection of documents to generate an audit report based on the search query, and providing the audit report for presentation on a client device. The audit generation model may be trained to generate a refined search query comprising one or more modifications to the received search query and extract portions of the collection of documents corresponding to the refined search query. The audit report may include one or more selectable options to verify relevancy of the extracted portions of the collection of documents corresponding to the refined search query.

The search query may include user-composed text. Generating the refined search query may include identifying one or more categories based on a parsing of the user-composed text using natural language processing. The search query may include one or more user-selected categories corresponding to a plurality of categories that the audit generation model has been trained to search when applied to the collection of documents.

The collection of documents may include a plurality of digital content items shared via a social networking system. The collection of documents may include a plurality of user-composed social networking posts shared via the social networking system. The collection of documents may include a plurality of digital content items shared across a plurality of social networking systems.

The audit generation model may be further trained to identify a reduced set of documents from the collection of documents prior to generating the refined search query. Generating the refined search query may include identifying one or more latent terms to utilize in identifying portions of the collection of documents in addition to the one or more search terms or in lieu of at least one search term from the one or more search terms. The audit generation model may include a machine learning model trained to generate the refined search query and extract portions of the collection of documents corresponding to the refined search query.

Extracting portions of the collection of documents corresponding to the refined search query may include identifying text snippets from the collection of documents corresponding to the refined search query. The audit generation model may be further trained to identify a subset of the extracted portions for presentation on the client device. Identifying the subset of the extracted portions may include one or more of identifying a random sample of the extracted portions of the collection of documents and determining a subset of extracted portions determined to have a higher correlation to the refined search query than one or more additional extracted portions.

Providing the audit report for presentation on the client device may include providing the audit report via a web application interface. Providing the audit report for presentation on the client device may include providing the audit report to the client device to enable the client device to locally generate and provide the presentation via a graphical user interface on the client device.

The method may further include receiving an indication of a user selection of the one or more selectable options and further training the audit generation model in view of the received indication of the user selection.

The method may further include receiving an additional search query comprising an additional set of one or more search terms and applying an updated version of the audit generation model based on further training of the audit generation model to the collection of documents or an additional collection of documents to generate an additional audit report based on the additional search query.

In accordance with another aspect of the present disclosure, a system is disclosed that includes at least one processor, memory in electronic communication with the at least one processor, and instructions stored in the memory. When executed by the at least one processor, the instructions may cause the system to receive from a client device a search query for searching a collection of documents, apply an audit generation model to the collection of documents to generate an audit report based on the search query, provide the audit report to the client device for presentation via a graphical user interface of the client device, and receive result feedback from the client device with respect to one or more results included within the audit report. The search query may include one or more search terms. Generating the audit report may include generating a refined search query comprising one or more modifications to the received search query and extracting portions of the collection of documents corresponding to the refined search query.

Applying the audit generation model to the collection of documents may include applying a machine learning model trained to generate the refined search query and extract portions of the collection of documents to the collection of documents. The system may further include instructions that, when executed by the at least one processor, cause the system to identify the collection of documents from one or more platforms from a plurality of social networking platforms.

Identifying the collection of documents may include selectively identifying a subset of available documents from a subset of the plurality of social networking platforms. The system may further include instructions that, when executed by the at least one processor, cause the system to receive an indication of a user selection of a platform of interest from the one or more platforms and identify the collection of documents from the platform of interest.

The one or more modifications to the received search query may include one or more latent variables to consider in addition to or in lieu of the one or more search terms from the search query. Generating the refined search query may include identifying one or more latent variables based on historical data associated with one or more previously generated audit reports and applying the one or more latent variables to the one or more search terms from the search query. The one or more latent variables may include one or more constraints to apply to the collection of documents in identifying portions of documents from the collection of documents to extract and include within the audit report.

Generating the refined search query may include identifying one or more sub-categories of a category determined to have relevance to the search query and adding the one or more sub-categories of the category to the one or more search terms of the search query. Generating the refined search query may include identifying one or more terms or categories associated with the search query determined to have little or no relevance to the search query and preventing the one or more terms or categories determined to have little or no relevance to the search query from influencing identification of the extracted portions of the collection of documents.

The system may further include instructions that, when executed by the at least one processor, cause the system to identify the collection of documents. Identifying the collection of documents may include performing a real-time monitoring of a plurality of documents as the plurality of documents are shared via a social networking system. The search query may include a request to perform a real-time search of the collection of documents as the plurality of documents are shared via the social networking system.

The system may further include instructions that, when executed by the at least one processor, cause the system to dynamically train or refine the audit generation model based on the received result feedback such that a refined audit generation model is applied to subsequently identified documents from the collection of documents.

In accordance with another aspect of the present disclosure, a computer-readable storage medium is disclosed that includes instructions thereon. When executed by at least one processor, the instructions may cause a computing device to apply an audit generation model to a collection of documents to generate an audit report based on a search query, provide the audit report to a client device, and provide the one or more user selections as training parameters for refining the audit generation model based on the detected one or more user selections. The audit report may include extracted portions of the collection of documents corresponding to the search query. Providing the audit report to the client device may cause the client device to provide via a graphical user interface of the client device a presentation of the audit report, the presentation of the audit report comprising a display of a plurality of query results based on the extracted portions of the collection of documents, and detect one or more user selections in connection with the plurality of query results indicating a measure of relevance with respect to one or more query results.

The presentation of the audit report may include a plurality of selectable options indicating a measure of relevance for an associated query result. The plurality of selectable options may include a selectable option to indicate that a corresponding search result is relevant to the search query, that the corresponding search result is not relevant to the search query, or that the corresponding search result has unknown relevance to the search query.

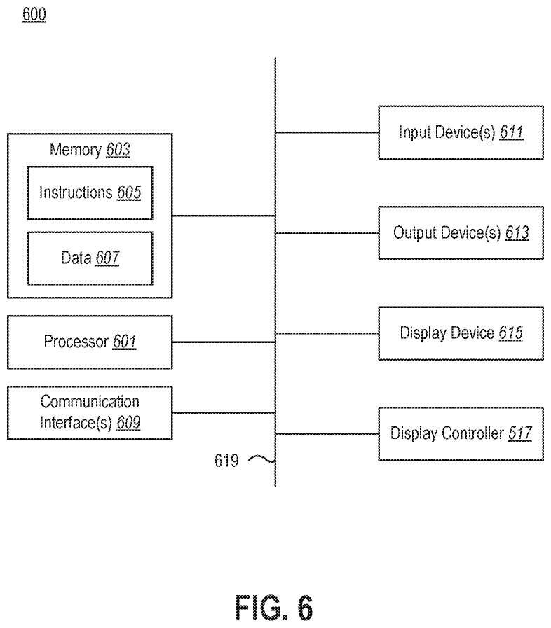

FIG. 6 illustrates certain components that may be included within a computer system 600. One or more computer systems 600 may be used to implement the various devices, components, and systems described herein.

The computer system 600 includes a processor 601. The processor 601 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a search query comprising one or more search elements;
analyzing, using a processor, a collection of documents to generate a query result based on the search query, wherein the query result comprises data for displaying portions of the collection of documents identified in the query result, each document portion being visually associated with a selectable user interface element that accepts user input to indicate relevancy of the document portion; and
providing the query result for presentation on a client device.

2. The method of claim 1, further comprising generating, from the search query, a refined search query by identifying one or more categories associated with the one or more search elements.

3. The method of claim 2, wherein the search query comprises one or more user-selected categories corresponding to a plurality of predetermined categories used to search the collection of document.

4. The method of claim 2, further comprising identifying a reduced set of documents from the collection of documents prior to generating the refined search query.

5. The method of claim 2, wherein generating the refined search query comprises identifying one or more terms not included in the one or more search elements to utilize in identifying portions of the collection of documents.

6. The method of claim 1, wherein the collection of documents comprises one or more of:
a plurality of digital content items shared via a social networking system;
a plurality of user-composed social networking posts shared via the social networking system; and
a plurality of digital content items shared across a plurality of social networking systems.

7. The method of claim 1, wherein the data for displaying portions of the collection of documents includes a visual indication of how the query result was generated, and wherein the visual indication is associated with a respective document portion from the identified portions of the collection of documents.

8. The method of claim 7,
wherein analyzing the collection of documents comprises using a machine learning model trained to obtain portions of a given collection of documents, and
wherein the visual indication of how the query result was generated includes data used by the machine learning model to select the respective document portion.

9. The method of claim 1, wherein the data for displaying the portions of the collection of documents comprises text snippets from the collection of documents.

10. The method of claim 1, wherein the data for displaying the portions of the collection of documents comprises a subset of the portions of the collection of documents for presentation on the client device.

11. The method of claim 10, wherein the data for displaying the portions of the collection of documents comprises one or more of:
a random sample of the portions of the collection of documents; and
a subset of the portions of the collection of documents determined to have a higher relevance to the search query than other portions.

12. The method of claim 1, wherein analyzing the collection of documents includes using a machine learning model trained to generate the search query and obtain the portions of the collection of documents.

13. The method of claim 12, further comprising:
receiving data, input via a selectable user interface element included in the search result, an indication of relevance associated with a displayed document portion; and
updating the machine learning model in view of the received indication of the user selection.

14. The method of claim 13, further comprising:
receiving an additional search query; and
applying the updated machine learning model to the additional search query to generate an additional query result based on the additional search query.

15. A system, comprising:
at least one processor; and
memory in electronic communication with the at least one processor; and
instructions stored in the memory, the instructions being executable by the one or more processors to:
receive a search query comprising one or more search elements;
analyze a collection of documents to generate a query result based on the search query, wherein the query result comprises data for displaying portions of the collection of documents identified in the query result, each document portion being visually associated with a selectable user interface element that accepts user input to indicate relevancy of the document portion; and
provide the query result for presentation on a client device.

16. The system of claim 15, further comprising instructions being executable to:
receive a selection of one or more categories associated with the one or more search elements; and
generate a refined search query including a modification to the search query based on the received selection of the one or more categories.

17. The system of claim 15, wherein the collection of documents comprises one or more of:
a plurality of digital content items shared via a social networking system;
a plurality of user-composed social networking posts shared via the social networking system; and
a plurality of digital content items shared across a plurality of social networking systems.

18. The system of claim 15, wherein analyzing the collection of documents includes using a machine learning model trained to generate the search query and obtain the portions of the collection of documents.

19. The system of claim 18, further comprising instructions being executable to:
receive data, input via a selectable user interface element included in the search result, an indication of relevance associated with a displayed document portion; and
update the machine learning model in view of the received indication of the user selection.

20. A computer-readable storage medium including instructions thereon that, when executed by at least one processor, cause a computing device to:
receive a search query comprising one or more search elements;
analyze a collection of documents to generate a query result based on the search query, wherein the query result comprises data for displaying portions of the collection of documents identified in the query result, each document portion being visually associated with a selectable user interface element that accepts user input to indicate relevancy of the document portion; and
provide the query result for presentation on a client device.
